(19) United States
(12) Patent Application Publication
(10) Pub. No.: US 2025/0232636 A1
(43) Pub. Date: Jul. 17, 2025

(54) APPARATUS AND METHOD FOR BACCARAT OPTION GAME

(71) Applicant: PARADISE SEGASAMMY Co., Ltd., Incheon (KR)

(72) Inventors: Makoto Kaneko, Incheon (KR); Bong Kyoon Kim, Incheon (KR); Da Ae Lee, Incheon (KR)

(73) Assignee: PARADISE SEGASAMMY Co. Ltd., Incheon (KR)

(21) Appl. No.: 18/990,976

(22) Filed: Dec. 20, 2024

(30) Foreign Application Priority Data
Dec. 21, 2023 (KR) 10-2023-0188341

(51) Int. Cl. G07F 17/32

(52) U.S. Cl. CPC G07F 17/322; G07F 17/3211; G07F 17/3258; G07F 17/3293

(57) ABSTRACT

Disclosed herein is an apparatus for a baccarat option game according to an embodiment, the apparatus including: a game table including a player card area, a banker card area, and an option betting area; a card reading device configured to sequentially distribute cards used in the game table and recognize, in order of distribution, card information including suits and numbers of the cards; a game calculation device configured to receive the card information from the card reading device and judge and determine game results; and a game display device configured to receive the game results from the game calculation device and display the received game results, in which at least one of the card reading device or the game calculation device may store at least one of baccarat game rules or predetermined option rules, the option rules may include one or more options and payout rates determined based on the suits and numbers of the cards used in the baccarat game, the option rules being applied independently of the baccarat game rules in each and every round of the baccarat game, and at least one of the card reading device or the game calculation device may be configured to judge and determine a winning of an option when the suits and numbers of the cards used in the baccarat game correspond to the predetermined option.

### CROSS REFERENCE TO RELATED APPLICATION

The present application claims priority to Korean Patent Application No. 10-2023-0188341, filed on Dec. 21, 2023, the entire contents of which is incorporated herein for all purposes by this reference.

### BACKGROUND OF THE INVENTION

### Field of the Invention

The present invention relates to an apparatus and method for a baccarat game, and more specifically, to an apparatus and method for a baccarat option game to which a novel option is applied in the baccarat game.

### Description of the Related Art

In casinos operating domestically and internationally, table games such as baccarat, poker, and blackjack are being conducted. In case of table games, dealers conduct the games at the respective tables. In table games, the dealer distributes cards according to predetermined rules, and wins and losses is determined based on the established game rules. In this case, the game player selects a betting target before the cards are distributed and places a bet with game chips. The dealer completes the game by awarding the game player a payout based on the odds, according to the winning or losing of the game.

A representative example of such table games is the baccarat game, which is conducted as a game where game players selectively bet on whether the banker will win, the player will win, or it will result in a tie based on the cards presented by the dealer. It is a game that many people can enjoy as participation is possible even without knowing the game rules. The baccarat game is a very popular game, but game players bet on whether the player or the banker will win, making it a game with a probability of about one-half, and it is difficult to obtain a large payout with a small amount, thereby limiting the interest of the game.

### SUMMARY OF THE INVENTION

The present invention is directed to providing an apparatus and method for a baccarat option game that applies novel options to a baccarat game, enhancing player interest and offering new enjoyment.

In addition, the present invention is directed to providing an apparatus and method for a baccarat option game capable of automatically judging and determining the winnings ofnovel options applied to a baccarat game.

In addition, the present invention is directed to providing an apparatus and method for a baccarat option game that enables additional high payouts based on winnings from novel options applied to a baccarat game, thereby offering customers significant anticipation.

In addition, the present invention is directed to providing an apparatus and method for a baccarat option game that applies a progressive jackpot to a baccarat game, enabling additional high payouts and offering customers significant anticipation.

There is provided an apparatus for a baccarat option game, according to an embodiment. The apparatus may include: a game table including a player card area, a banker card area, and an option betting area; a card reading device configured to recognize, in order of use, card information including suits and numbers of cards used on the game table; a game calculation device configured to receive the card information from the card reading device and judge and determine game results; and a game display device configured to receive the game results from the game calculation device and display the received game results, in which at least one of the card reading device or the game calculation device may store at least one of baccarat game rules or predetermined option rules, the option rules may include one or more options and payout rates determined based on the suits and numbers of the cards used in the baccarat game, the option rules being applied independently of the baccarat game rules in each and every round of the baccarat game, and at least one of the card reading device or the game calculation device may be configured to judge and determine a winning of an option when the suits and numbers of the cards used in the baccarat game correspond to the predetermined option.

The option betting area may further include a betting detection sensor configured to detect a betting amount of chips positioned in the option betting area, and the betting amount detected by the betting detection sensor may be transmitted to the game calculation device.

The apparatus may further include a jackpot calculation device configured to receive the betting amount detected by the betting detection sensor and save a portion of the betting amount as a jackpot according to a predetermined jackpot calculation method.

The game results may include winning results of the option, and upon winning of the option, the winning results may be displayed as an image on the game display device.

The card reading device and the game calculation device may be configured as a single device.

There is provided a method for a baccarat option game, according to an embodiment, performed in an apparatus for a baccarat option game comprising a game table including a player card area, a banker card area, and an option betting area, a card reading device configured to distribute cards used on the game table and recognize card information; and a game calculation device configured to receive information on the cards used in the game from the card reading device, the method may include: distributing, by the card reading device, cards to the player card area and the banker card area according to baccarat game rules; detecting, by the game table, an option betting amount, using a betting detection sensor positioned in the option betting area; transmitting the detected betting amount to the game calculation device; receiving, by the game calculation device, the card information from the card reading device and, based on the card information; and judging and determining, by the game calculation device, whether the option has been won or lost according to predetermined option rules, in which the option rules may include one or more options and corresponding payout rates determined based on suits and numbers of cards disposed in the player card area and the banker card area, and the game calculation device calculates a winning amount based on the option betting amount, according to a payout rate of an winning option.

The option rules may include a single pair option, which has a predetermined payout rate when first two cards disposed in the player card area have the same number or when first two cards disposed in the banker card area have the same number.

The option rules may include a double pair option, which has a payout rate larger than the payout rate of the single pair option when first two cards disposed in the player card area have the same number and when first two cards disposed in the banker card area have the same number.

The option rules may include a twin pair option, which has a payout rate larger than the payout rate of the double pair option when first two cards disposed in the player card area and first two cards disposed in the banker card area all have the same number.

The option rules may include a single 3-card option, which has a payout rate larger than the payout rate of the single pair option when three cards disposed in the player card area have the same number or when three cards disposed in the banker card area have the same number.

The option rules may include a 3-card & pair option, which has a payout rate larger than the payout rate of the single 3-card option when first two cards disposed in one area of the player card area or the banker card area have the same number, and three cards disposed in the other area have the same number.

The option rules may include a 3-card & twin pair option, which has a payout rate larger than the payout rate of the 3-card & pair option when first two cards disposed in one area of the player card area or the banker card area, and three cards disposed in the other area, all have the same number.

The option rules may include a double 3-cards option, which has a payout rate larger than the payout rate of the 3-card & pair option when three cards disposed in the player card area have the same number and three cards disposed in the banker card area have the same number.

The option rules may include a twin 3-cards option, which has a payout rate larger than the payout rate of the double 3-cards option when three cards disposed in the player card area and three cards disposed in the banker card area all have the same number.

The option rules may include a straight flush option, which has a predetermined payout rate when five cards of cards disposed in the player card area and the banker card area are of the same suit and correspond to consecutive numbers.

The option rules may include a royal straight flush option, which has a payout rate larger than the payout rate of the straight flush option when the consecutive numbers in the straight flush option correspond to Ace (A), King (K), Queen (Q), Jack (J), and 10.

In the method for a baccarat option game, according to an embodiment, when cards disposed in the player card area and the banker card area correspond to multiple option rules, it may be judged and determined as a winning for an option with a largest payout amount.

According to the embodiments, applying novel options to a baccarat game can enhance players' interest and offer new enjoyment, thereby increasing players' participation rates. Consequently, this can serve as an additional revenue source for casinos.

In addition, according to the embodiments, the winning results ofnovel options applied to a baccarat game can be automatically judged and determined, preventing cases where a dealer may miss the winnings of option betting that follow rules different from the existing game.

In addition, according to the embodiments, the results of novel options applied to a baccarat game and additional high payouts based on a progressive jackpot can be facilitated, thereby increasing game players' participation rates and providing an additional revenue source for casinos.

### BRIEF DESCRIPTION OF THE DRAWINGS

FIGS. 1 and 2 are views for describing an apparatus for a baccarat option game according to an embodiment of the present invention.

FIG. 3 is an exemplary layout view of a card disposition area according to an embodiment.

FIG. 4 is an exemplary layout view of a betting area according to an embodiment.

FIG. 5 is a block diagram of an apparatus for a baccarat option game, according to an embodiment.

FIG. 6 is a flowchart of a standard baccarat game according to an embodiment.

FIG. 7 is an example of a condition judgment table used in the embodiment of FIG. 6.

FIG. 8 is a flowchart of an option determination according to an embodiment.

FIG. 9 is an example of a payout multiplier table used in the embodiment of FIG. 8.

FIG. 10 is a flowchart of a screen display after option winning according to an embodiment.

### DETAILED DESCRIPTION OF THE INVENTION

Hereinafter, several exemplary embodiments of the present invention will be described in detail with reference to the accompanying drawings so that those with ordinary skill in the art to which the present invention pertains may easily carry out the exemplary embodiments. The present invention may be implemented in various different ways and is not limited to the embodiments described herein. To clearly describe the present invention, reference numerals for portions unrelated to the description have been omitted, and throughout the specification, identical or similar constituent elements are assigned the same reference numerals, with redundant descriptions thereof omitted.

In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

Throughout the specification, unless explicitly described to the contrary, the word “comprise/include” and variations such as “comprises/includes” or “comprising/including” will be understood to imply the further inclusion of stated elements but not the exclusion of any other elements.

In addition, when one constituent element is described as being “connected”, “coupled”, or “attached” to another constituent element, it should be understood that one constituent element can be connected or attached directly to another constituent element, and other constituent elements may be “interposed” between each constituent element, or that each constituent element may be “connected,” “coupled,” or “attached” through other constituent elements.

Various exemplary embodiments of the present invention will be described in detail below with reference to the drawings.

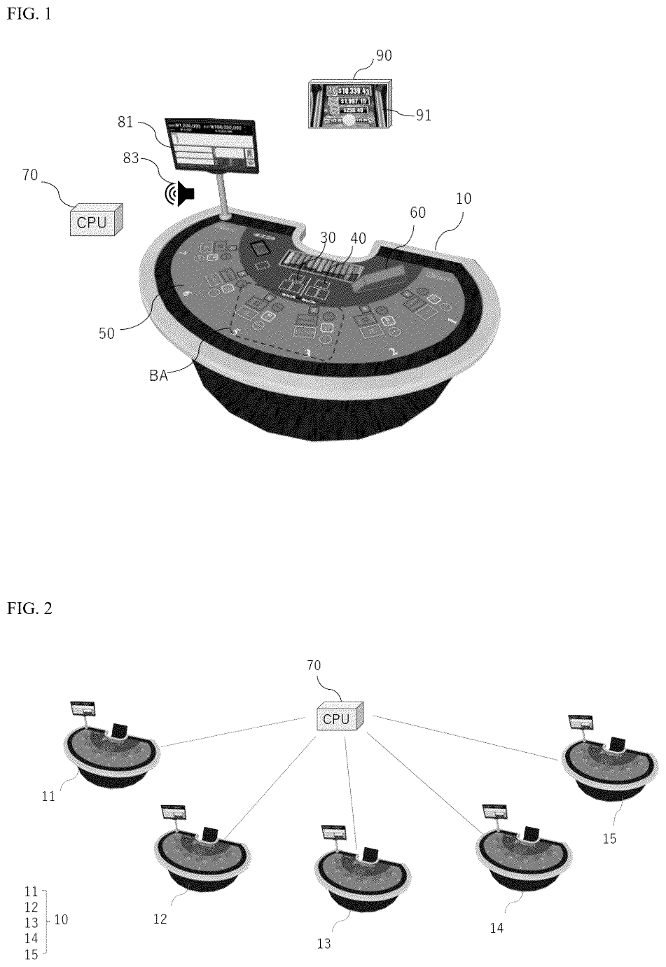

FIGS. 1 and 2 are views for describing an apparatus for a baccarat option game according to an embodiment of the present invention.

With reference to FIG. 1, an apparatus for a baccarat option game according to an embodiment may include a game table 10, a card reading device 60, a game calculation device 70, a game display device 81, and a jackpot calculation device 90.

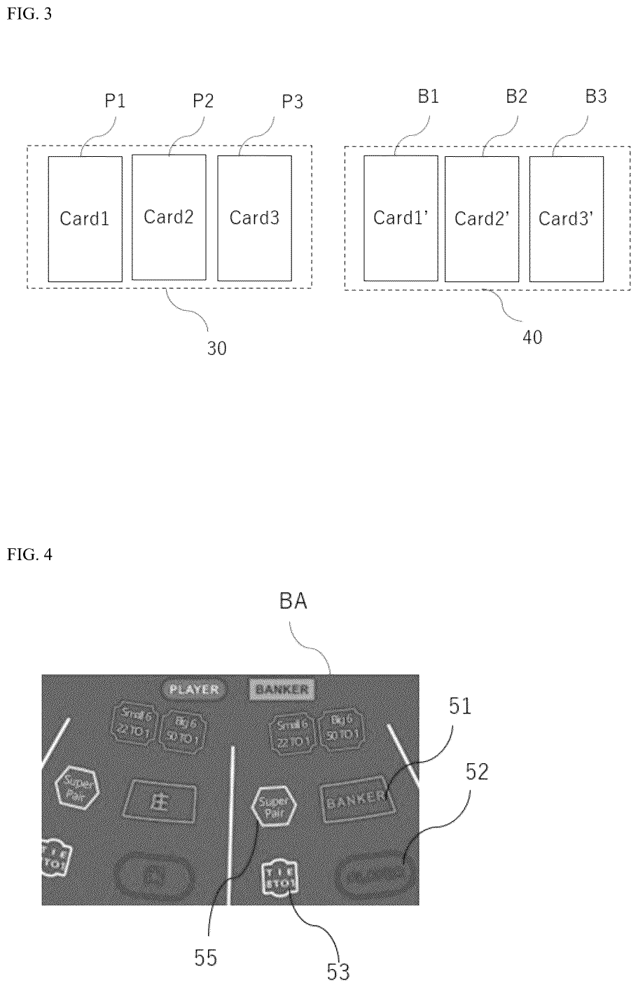

The game table 10 according to an embodiment may include a card disposition area 30 and 40, which is an area where a dealer places cards to advance the game for during the progression of the card game, a game player area 50 where players are positioned, and a betting area BA where the players place chips for betting in the game. A detailed description of the card disposition area 30 and 40 will be provided below with reference to FIG. 3.

The game player area 50 may include multiple areas to allow a number of game players to participate in the game, for example, the game player area 50 may be divided and disposed to allow six game players to take part in the game. The game player area 50 may include Arabic numerals or the like to mark a spot for each game player, and may not include a specific number (e.g., the number 4) depending on customer preferences. In an embodiment, six players may participate in the game in a game player area marked and divided into 1, 2, 3, 5, 6, and 7, respectively. According to an embodiment, the game player area 50 may be variously divided by various numbers, symbols, shapes, and the like.

Each game player area 50 may include respective betting areas BA. According to an embodiment, in the game player area 50, the betting area BA may be divided and disposed separately for each game player. The betting area BA is an area where a game player positions chips to place bets on the game. Each betting area BA may include basic betting areas, including a banker betting area 51, a player betting area 52, a tie betting area 53, and an option betting area 55. In addition, the betting area BA may further include a jackpot betting area (not illustrated). A detailed description of the betting area BA will be provided below with reference to FIG. 4.

The card reading device 60 may distribute cards used in the game, read what cards being distributed are (e.g., suit, number, color, etc.), and store the cards. Card information on cards sequentially distributed from the card reading device 60 may be transmitted to the game calculation device 70. In another embodiment, the cards distributed in the game may be image-recognized using a camera device (not illustrated). The recognized card information is transmitted to the game calculation device 70, and the game calculation device 70 may judge and determine, according to predetermined rules of the game, the winning or losing of the game, such as game completion, game results, option winnings, and jackpot winnings.

According to an embodiment, the card reading device 60 may pre-store the determined rules of the game, read information on ejected cards, apply the pre-stored rules of the game to judge and determine the winning or losing of the game by itself, such as game completion, game results, option winnings, and jackpot winnings, and transmit the judged and determined game results to the game calculation device 70.

The game calculation device 70 stores the predetermined rules of the game and may receive card information dealt from the card reading device 60 to judge and determine the winning or losing of the game, including game completion, game results, option winnings, and jackpot winnings, according to the predetermined rules of the game. In addition, the game calculation device 70 may perform a calculation of an option payout rate based on a predetermined rule when the option is won at the completion of the game. Specific details regarding the option and payout rate will be described below with reference to [Table 1].

Through such a card reading device 60 and/or game calculation device 70, the winning of an option game, which is applied with rules different from conventional games, may be automatically judged and determined without missing.

In an embodiment, the card reading device 60 and/or game calculation device 70 may be implemented to include program code (software constituent element) that performs the aforementioned functions and/or hardware constituent elements capable of storing and executing the program code, or a combination of software constituent elements and hardware constituent elements. In addition, according to an embodiment, the card reading device 60 and the game calculation device 70 may be combined and implemented as a single hardware constituent element in which programs performing each function are stored.

With reference to FIG. 2, the game calculation device 70 according to an embodiment may be connected to multiple game tables 10 and may transmit and receive game information such as game completion, game results, and the winning of options and jackpots from the multiple game tables 10. According to an embodiment, the game calculation device 70 may be independently provided and linked for each game table 11, 12, 13, 14, or 15, and transmit information such as game completion, game results, and the winning of options and jackpots for each game table 11, 12, 13, 14, or 15 to the game display device 81 and/or speaker 83 of the respective game tables 11, 12, 13, 14, and 15.

The game display device 81 may be disposed for each game table 11, 12, 13, 14, or 15, and may receive and display at least one piece of information such as game completion, game results, option winnings, and jackpot winnings from the game calculation device 70. In addition, the winning may be notified through the speaker 83 or displayed along with dynamic images, preventing the dealer and game players from missing the winning and providing greater enjoyment to the customers.

The jackpot calculation device 90 may receive a betting amount placed on an option for each and every game and determine an amount to be added to the jackpot according to a predetermined jackpot calculation method. In addition, the jackpot calculation device 90 may include a jackpot indicator 91 that displays the jackpot status. By adding to the jackpot amount to date and displaying the jackpot amount on the jackpot indicator 91, the jackpot calculation device 90 may offer great anticipation to the game players and visualize the increasing jackpot amount, enhancing their enjoyment.

With reference to FIG. 2, the game calculation device 70 is connected to multiple game tables 11, 12, 13, 14, and 15 and, in case of winning a jackpot, may transmit information regarding which table the jackpot occurred at to the jackpot calculation device 90. The jackpot calculation device 90 may receive information on whether to win the jackpot and the game table where the jackpot occurred from the game calculation device 70. Accordingly, the jackpot calculation device 90 may display the type of jackpot won and/or the jackpot amount based on the winning card value on the jackpot indicator 91 or notify this information through additional means such as a speaker. According to an embodiment, the jackpot indicator 91 may be implemented and disposed separately from the jackpot calculation device. In addition, the jackpot calculation device 90 may set and display a new jackpot amount based on the calculation method determined after a jackpot win.

In this manner, the apparatus and method for a baccarat option game according to an embodiment may provide a progressive jackpot where the jackpot amount increases at a fixed rate each time the betting amount increases across multiple tables. In an embodiment, the jackpot may be designated for cases corresponding to a specific option. Alternatively, cases corresponding to the jackpot may be determined independently of the option rules and may be predetermined based on at least one of the suits, numbers, or colors of the cards.

As an embodiment, when the entire cards used in the baccarat game correspond to a straight flush (a case that consecutive numbers of the same suit appear with a combination of five cards among the player and banker cards), a royal straight flush (a case that A, K, Q, J, and 10 of the same suit appear with a combination of five cards among the player and banker cards), or twin 3-card (a total of six cards from the player and banker cards have the same number), it may be designated as a jackpot win. In this case, for example, a payout corresponding to 300 times the option betting amount may be awarded, and additionally, a predetermined percentage (e.g., 5%, 10%, etc.) of the winning amount may be added to the jackpot amount to implement a progressive jackpot. The payout awarding rates, jackpot selection, and the percentage saved in the jackpot on the option betting may vary and be applied differently depending on the embodiment.

FIG. 3 is an exemplary layout view of a card disposition area according to an embodiment.

The card disposition area 30 or 40 is an area where cards are positioned during the progression of the game and may include a player card area 30, where the player's cards are disposed, and a banker card area 40, where the banker's cards are disposed. For example, the cards used may be playing cards with numbers and symbols displayed on one side. The player cards and banker cards may be alternately distributed from the card reading device 60, for example, in the order of P1, B1, P2, B2, P3, and B3. The player cards may be disposed in the player card area 30 in the order of P1, P2, and P3, and the banker cards may be disposed in the banker card area 40 in the order of B1, B2, and B3. According to the embodiment, the disposition layout of the cards disposed in the card disposition area may be implemented in various ways.

For example, three player cards P1, P2, and P3 may be disposed in the player card area 30, and three banker cards B1, B2, and B3 may be disposed in the banker card area 40. In the baccarat game, a game may be completed with a total of four cards consisting of two player cards P1 and P2 and two banker cards B1 and B2. Alternatively, the game may be completed with a total of five cards consisting of three player cards P1, P2, and P3 and two banker cards B1 and B2. Furthermore, the game may be completed with a total of six cards consisting of three player cards P1, P2, and P3 and three banker cards B1, B2, and B3.

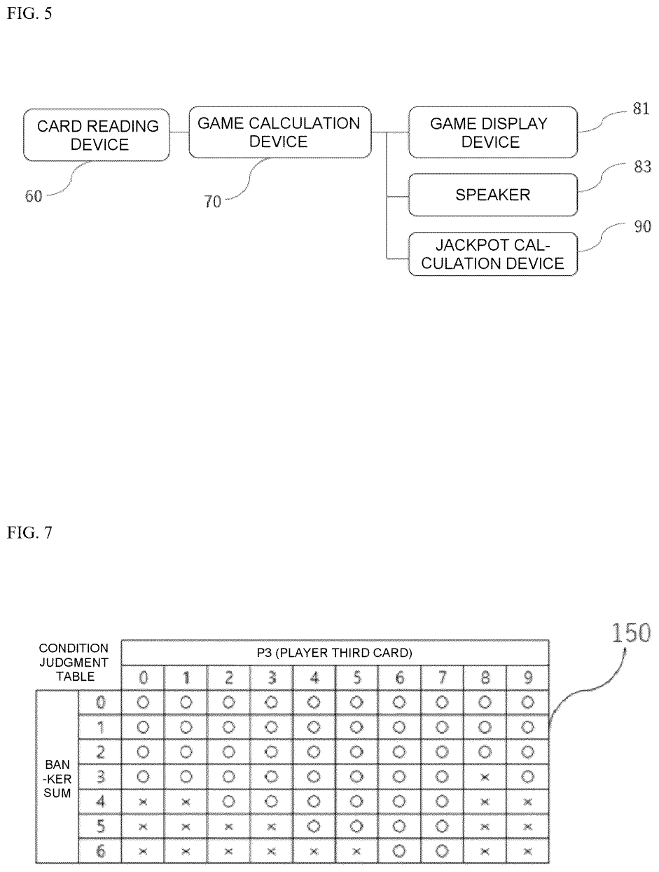

After the baccarat game is completed, whether the baccarat option is won or lost may be determined based on the combination of suits and numbers of the total cards disposed in the card disposition area. Specific details regarding whether the baccarat option is won or lost according to an embodiment will be described below with reference to FIG. 5 and [Table 1].

FIG. 4 is an exemplary layout view of a betting area according to an embodiment.

The betting area BA is an area where game players position chips to place bets in the game. Each betting area BA may include basic betting areas, including the banker betting area 51, player betting area 52, tie betting area 53, and option betting area 55. The betting area BA may further include the jackpot betting area (not illustrated).

In FIG. 4, the option betting area 55 for option betting is illustrated and described as being included in each player's betting area BA, but the present invention is not limited thereto. According to an embodiment, the option betting area 55 may be installed at a different position distinct from each player's betting area BA.

The game players may place one or more bets for the baccarat option game, including basic betting on the results of the baccarat game and/or option betting. The option betting may be conducted independently of basic betting and may also be placed as a standalone bet without any basic betting. The minimum and maximum betting amounts per game player, as well as the total betting amount limit for the table, are set according to predetermined rules and may be appropriately modified and applied depending on the embodiment.

Such betting is designated by placing chips on a predetermined betting area on the game table 10. Here, the basic betting involves predicting the winning or losing of the basic baccarat game, with bets placed on the banker betting area 51, player betting area 52, or tie betting area 53. The option bet refers to placing bets on the option betting area 55 for betting on options in the baccarat game. The chips used for betting are standard regulated chips, which may be, for example, money chips, lucky chips, or match chips.

Since the option betting has larger payout rates compared to the basic betting, the option betting area 55 may be formed to differ in at least one of area, color, or shape from the basic betting areas (e.g., banker betting area, player betting area, tie betting area) to make the option betting area 55 more prominent. For example, the option betting area 55 may have a larger area than the basic betting areas 51, 52, and 53 and be formed with a noticeable color. In addition, the option betting area 55 may include noticeable graphics or text (e.g., phrases such as “Paradise Super Pair,” “Super Pair,” or “Tiger Pair Plus”).

In addition, the option betting area 55 may be disposed in a position farther from the game players or closer to the dealer side compared to the basic betting areas (e.g., banker betting area, player betting area, tie betting area). Accordingly, the dealer and other players participating in the game may easily and visually identify whether bets have been placed on the option betting area 55, thereby preventing fraudulent play by game players.

Each betting area 51, 52, 53, or 55 may include a betting detection sensor (not illustrated) to detect the betting amount of chips placed in each betting area. The betting detection sensor may be disposed across the entirety of the betting area BA or may be disposed individually in each betting area 51, 52, 53, or 55.

For example, the betting detection sensor may detect the betting amount by sensing the IC tags embedded in the chips used in the game. Alternatively, the betting amount for each betting area 51, 52, 53, or 55 may be input through an external input device. Alternatively, the chips placed in each betting area 51, 52, 53, or 55 may be image-recognized using an image camera device (not illustrated), allowing the betting amount in each betting area to be judged and determined accordingly.

According to an embodiment, the betting amount in each betting area 51, 52, 53, or 55 may be detected for each and every game, and the detected betting amount may be transmitted to the game calculation device 70 and/or the jackpot calculation device 90.

FIG. 5 is a block diagram of an apparatus for a baccarat option game, according to an embodiment of the present invention.

With reference to FIG. 5, the apparatus for a baccarat option game according to an embodiment may include the card reading device 60, the game calculation device 70, the game display device 81, the speaker 83, and the jackpot calculation device 90. The card reading device 60 may distribute and recognize the cards used in the game, and transmit the card information used to the game calculation device 70. The game calculation device 70 pre-stores the predetermined rules of the game and may receive card information recognized from the card reading device 60 to judge and determine the winning or losing of the game, including game completion, game results, option winnings, and jackpot winnings, according to the predetermined rules of the game. For example, the game calculation device 70 may store the basic baccarat game rules and may also store novel option rules applied to the baccarat game.

The baccarat option rules according to an embodiment are as follows.

TABLE 1

| Option Name | Option Description | Payout Amount |
|---|---|---|
| Single Pair | When only one of the following | 4 times betting |
| | occurs: the first two player cards | amount |
| | have the same number (hereinafter, | |
| | Player Pair) or the first two | |
| | banker cards have the same number | |
| | (hereinafter, Banker Pair). | |
| | (However, a case where a larger | |
| | high payout is won simultaneously | |
| | are excluded.) | |
| Double Pair | When both a Player Pair and a | 20 times the bet |
| | Banker Pair occur simultaneously | amount |
| | (However, a case where a larger high | |
| | payout is won simultaneously are | |
| | excluded.) | |
| Twin Pair | When both a Player Pair and a | 100 times the bet |
| | Banker Pair occur simultaneously, | amount |
| | and the numbers on both sides are | |
| | the same (However, a case where a | |
| | larger high payout is won | |
| | simultaneously are excluded.) | |
| Single 3-Card | When only one of the following | 14 times the bet |
| | occurs: three player cards have | amount |
| | the same number (hereinafter, Player | (4 times + 10 |
| | 3-Card) or three banker cards have | times) |
| | the same number (hereinafter, Banker | |
| | 3-Card) | |
| 3-Card & Pair | When a Player 3-Card and a Banker | 30 times the bet |
| | Pair occur simultaneously, or when | amount |
| | a Banker 3-Card and a Player Pair | (20 times + 10 |
| | occur simultaneously (However, a | times) |
| | case where a larger high payout is | |
| | won simultaneously are excluded.) | |
| 3-Card & Twin | When a Player 3-Card and a Banker | 110 times the bet |
| Pair | Pair occur simultaneously, and the | amount |
| | numbers are the same, or when a | (100 times + 10 |
| | Banker 3-Card and a Player Pair | times) |
| | occur simultaneously, and the | |
| | numbers are the same (However, a | |
| | case where a larger high payout is | |
| | won simultaneously are excluded.) | |
| Double 3-Cards | When a Player 3-Card and a Banker | 40 times the bet |
| | 3-Card occur simultaneously | amount |
| | (However, a case where a larger | (20 times + 10 |
| | high payout is won simultaneously | times + 10 times) |
| | are excluded.) | |
| Straight Flush | When a Straight Flush (consecutive | 100 times the bet |
| | numbers of the same suit) appears | amount |
| | with a combination of five cards | |
| | among the Player and Banker cards | |
| | (up to 6 cards) | |
| Royal Straight | When a Royal Straight Flush (A, | 200 times the bet |
| Flush | K, Q, J, 10 of the same suit) | amount |
| | appears with a combination of | |
| | five cards among the Player and | |
| | Banker cards (up to 6 cards) | |
| Twin 3-Cards | When a Player 3-Card and a Banker | 300 times the bet |
| | 3-Card occur simultaneously, and | amount |
| | all six cards have the same number | |

The game calculation device 70, after completing the basic baccarat game, may calculate whether the option is won or lost and the option payout rate based on the option rules in [Table 1]. The payout amount for each option as described above is merely an embodiment, but is not limited thereto, and the type of each option and the corresponding payout rates may vary widely and applied depending on the embodiment. In addition, the option rules may be independently applied to each and every round of the baccarat game. Accordingly, game players may experience increased interest in the game and heightened anticipation for winnings with each and every round. In addition, the baccarat option game may provide the effect of allowing game players to participate in an additional game simultaneously while taking part in a single baccarat game.

The game calculation device 70 may judge and determine the winning or losing of the basic baccarat game, whether the option is won or lost, and whether the jackpot is won or lost, and transmit the judged and determined game results to the game display device 81, the speaker 83, and/or the jackpot calculation device 90. The game calculation device 70 may be provided individually for the multiple game table 10 or a single game calculation device 70 may be connected to the multiple game tables 10. Accordingly, the implementation of a progressive jackpot, where the winning amount accumulates, becomes possible, allowing game players to become more immersed in the game.

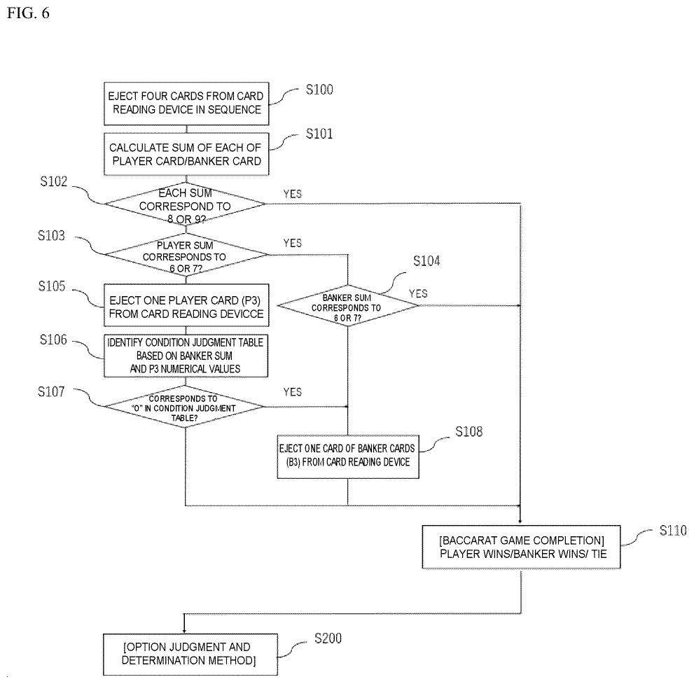

Hereinafter, with reference to FIGS. 6 to 10, the overall flow of the baccarat option game according to an embodiment of the present invention will be described.

FIG. 6 is a flowchart of a standard baccarat game according to an embodiment. The standard baccarat game involves the dealer dealing the player cards and banker cards according to baccarat rules, then comparing the sum of the numbers on both sides' cards, with the side closer to 9 winning.

With reference to FIG. 6, first, four cards are sequentially distributed from the card reading device (step S100). The cards are distributed in the order of player card P1, banker card B1, player card P2, and banker card B2, and the card reading device may read the card information (e.g., number, suit, color, etc.) as being distributed.

Subsequently, the sum of the numbers on the two player cards and the sum of the numbers on the two banker cards are each calculated (step S101). When calculating the sum of the card numbers, an Ace (A) is calculated as 1, Kings (K), Queens (Q), Jacks (J), and 10s are calculated as 0, and the other cards from 2 to 9 are calculated based on the numbers displayed on their faces. When the sum is 10 or higher, the tens digit is ignored, and only the ones digit is calculated.

It is judged whether at least one of the sum of the player card or the sum of the banker card corresponds to 8 or 9 (step S102). When the sum of either side corresponds to 8 or 9, no additional cards are distributed, and the baccarat game is completed (S110). After the game has been completed, the sum of the player cards and the sum of the banker cards are compared. The side with the larger sum (closer to 9) is judged and determined as the winner, and when the sums are equal, it is judged and determined as a tie.

Meanwhile, when neither sum corresponds to 8 or 9 in step S102, it is judged whether the sum of the player cards corresponds to 6 or 7 (step S103). In step S103, when the sum of the player cards corresponds to a 6 or 7, it is judged whether the sum of the banker cards corresponds to a 6 or 7 (S104), and if so, no additional cards are distributed, and the baccarat game is completed (S110). In step S104, when the sum of the banker cards does not correspond to 6 or 7, one additional banker card is distributed from the card reading device (S108).

In step S103, when the sum of the player cards does not correspond to 6 or 7, one additional player card is distributed from the card reading device (S105). Subsequently, a condition judgment table (150, see FIG. 7) may be identified based on the sum of the banker cards and the number of additionally distributed player cards (i.e., the player's third card) (S106).

With reference to FIG. 7, the condition judgment table 150 is a judgment table that records whether to distribute additional cards in each case where the player's third card corresponds to 0 to 9, for each case where the sum of the two banker cards is 0 to 6. When the intersection of the sum of the banker card and the number of the player's third card corresponds to “O” in the condition judgment table 150 (S107), one additional banker card is distributed from the card reading device (S108), and the baccarat game is completed (S110).

In step S107, when the intersection does not correspond to “O” in the condition judgment table 150, no additional cards are distributed, and the baccarat game is completed (S110). After the game has been completed, the sum of the player cards and the sum of the banker cards are compared. The side with the higher sum (closer to 9) is judged and determined as the winner, and when the sums are equal, it is judged and determined as a tie.

After the baccarat game described above is completed, an option judgment and determination method is initiated (S200).

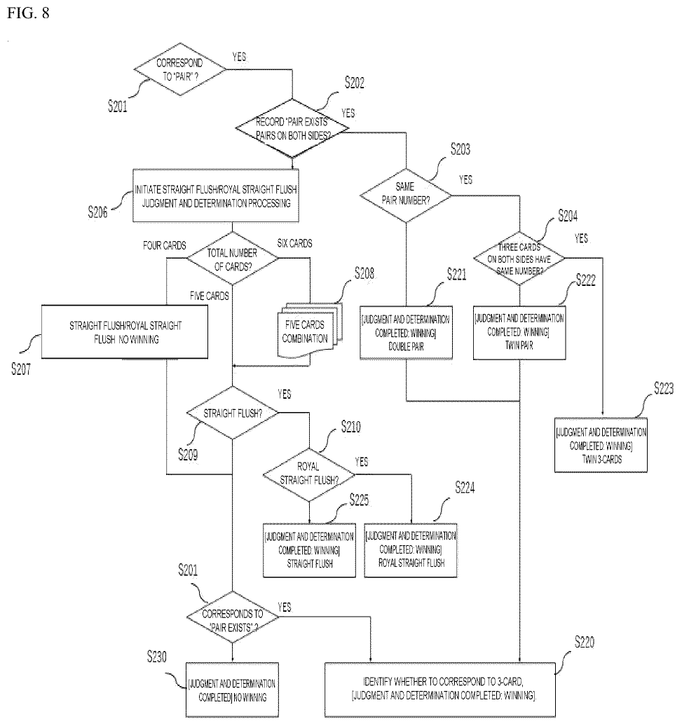

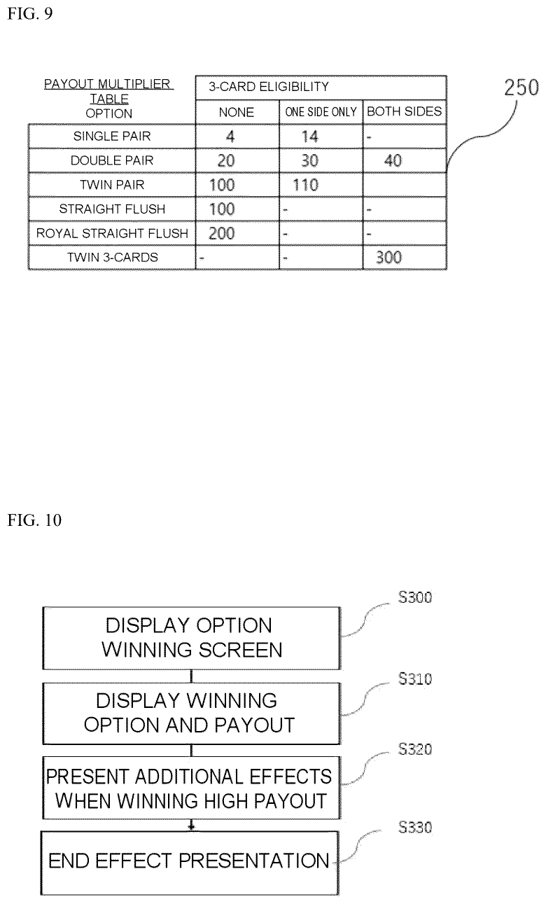

FIG. 8 is a flowchart of an option judgment and determination according to an embodiment, and FIG. 9 is an example of a payout multiplier table used in the embodiment of FIG. 8.

With reference to FIG. 8, first, it is judged and determined whether a pair exists among the cards on both sides distributed by the card reading device (S201). In an embodiment, it may be judged and determined as a “pair” when the two initially distributed player cards P1 and P2 have the same number or when the two initially distributed banker cards B1 and B2 have the same number. When corresponding to a pair, the information of “pair exists” is recorded or stored, and it is further judged and determined whether both sides correspond to pairs (S202).

When pairs exist on both the player cards and the banker cards in step S202, it is judged in step S203 whether the numbers corresponding to each pair on both sides are the same.

When the numbers of the pairs on both sides are not the same in step S203, it is judged and determined as a winning for the “double pair” option (S221). Subsequently, it is finally judged and determined whether the three player cards have the same number or whether the three banker cards have the same number, corresponding to a 3-card. After this, the option judgment and determination is completed (S220). When not corresponding to the 3-card in step S220, it is finally judged and determined as a winning for the double pair option. A payout corresponding to 20 times the betting amount, which is a winning amount based on the payout multiplier table (250, see FIG. 9), may be awarded. When corresponding to the 3-card, an additional payout of 10 times the original payout multiplier is added, based on the payout multiplier table 250. For example, when corresponding to the double pair option and when all three player cards have the same number, it corresponds to the double pair and 3-card option. A payout of 30 times, which is the original 20 times payout (double pair payout)+10 times payout (3-card), may be awarded. When all three player cards have the same number and all three banker cards also have the same number, a payout of 40 times, which is the original 20 times payout (double pair payout)+10 times payout (player 3-card)+10 times payout (banker 3-card), may be awarded.

Meanwhile, when the numbers of the pairs on both sides are the same in step S203, it is further judged in step S204 whether the third player card and the third banker card have been distributed and whether the third player card and the third banker card have the same number as the pairs.

In step S204, when both the third player card and the third banker card have been in a distributed state and the three cards on both sides have the same number, it is judged and determined as a winning for the “twin 3-card” option, and the option judgment and determination is completed (S223). A payout of 300 times the betting amount (corresponding to the twin 3-card), which is a winning amount, may be awarded based on the payout multiplier table 250.

When, in step S204, either the third player card and the third banker card have not both been distributed, or the third player card and the third banker card have both been distributed but the numbers of the three cards on both sides are not the same, it is judged and determined as a winning for the “twin pair” option (S222). Subsequently, it is finally judged and determined whether the three player cards have the same number or whether the three banker cards correspond to the 3-card, in which three cards have the same number. After this, the option judgment and determination is completed (S220). When not corresponding to the 3-card, it is judged and determined as a winning for the twin pair option, and a payout of 100 times the betting amount, which is a winning amount based on the payout multiplier table (250), may be awarded. When corresponding to the 3-card, an additional payout of 10 times the original payout multiplier is added, based on the payout multiplier table 250. For example, when corresponding to the twin pair option and when all three cards on one side of the player cards or the banker cards have the same number, it corresponds to the twin pair and 3-card option. A payout of 110 times, which is the original 100 times payout (twin pair payout)+10 times payout (3-card), may be awarded. When all three player cards have the same number and all three banker cards also have the same number, it corresponds to the twin 3-card. A payout of 300 times the betting amount, which is a winning amount based on the payout multiplier table 250, may be awarded.

When corresponding to “pair exists” in step S202 but not corresponding to pairs on both sides, the judgment and determination process for a straight flush/royal straight flush is initiated (S206).

At the completion of a baccarat game according to an embodiment, since the total number of cards used in the game may be 4, 5, or 6, the option judgment and determination is performed according to each case.

When the total number of cards at game completion is 4, it cannot correspond to the straight flush/royal straight flush option, which requires a total of five cards. Therefore, it is judged and determined as “no winning of straight flush/royal straight flush” (S207).

When the total number of cards at game completion is 5, it is judged and determined whether the five cards used correspond to a straight flush, which consists of consecutive numbers of the same suit (S209). When the total number of cards at game completion is 6, prior to proceeding with step S209, the combinations of five cards are processed for the 6 possible cases of selecting five cards from the total 6 cards (S208). Subsequently, step S209 is performed.

When not corresponding to a straight flush in step S209, it is identified whether a pair exists (S201). Subsequently, when no pair exists, it corresponds to “no winning,” and the option judgment and determination is completed (S230).

When a pair exists in step S201, it is judged and determined as a single pair. Subsequently, it is further judged and determined whether the three player cards have the same number or whether the three banker cards correspond to the 3-card, in which three cards have the same number. After this, the option judgment and determination is completed (S220). When not corresponding to the 3-card, it is finally judged and determined as a winning for the single pair option. A payout of 4 times the betting amount, which is a winning amount based on the payout multiplier table 250, may be awarded. When corresponding to the 3-card, an additional payout of 10 times the original payout multiplier is added, based on the payout multiplier table 250. For example, when corresponding to the single pair option and when all three player cards have the same number, it corresponds to the single 3-card option. A payout of 14 times, which is the original 4 times payout (single pair payout)+10 times payout (3-card), may be awarded.

When corresponding to a straight flush in step S209, it is further judged and determined in step S210 whether the five cards correspond to a royal straight flush, which consists of Ace (A), King (K), Queen (Q), Jack (J), and 10, subsequently.

When not corresponding to a royal straight flush in step S210, it is judged and determined as a winning for the straight flush option, and the option judgment and determination is completed (S225). A payout of 100 times the betting amount, which is a winning amount based on the payout multiplier table 250, may be awarded.

When corresponding to a royal straight flush in step S210, it is judged and determined as a winning for the royal straight flush option, and the option judgment and determination is completed (S224). A payout of 200 times the betting amount, which is a winning amount based on the payout multiplier table 250, may be awarded.

These operations may be performed by a baccarat option device that includes a card reading device and/or a game calculation device in a casino game environment, or by a game machine or online game system equipped with corresponding program code modules implementing algorithms that programmatically implement baccarat rules and/or option rules. In an embodiment involving a game machine or an online game system, the methods may be encoded and implemented as program code executed by a processor.

In this manner, the baccarat option game according to an embodiment progresses with the basic baccarat game while simultaneously performing additional option judgments and determinations. This allows game players to enjoy the excitement and thrill of participating in two or more games simultaneously in each and every round while progressing with the basic baccarat game, thereby enhancing player engagement and immersion.

FIG. 10 is a flowchart of a screen display after option winning according to an embodiment.

With reference to FIG. 10, after the option judgment and determination of FIG. 9 is completed, it may be announced whether the option has been won or lost. For example, whether the option has been won or lost may be displayed through the screen of the game display device (S300). Subsequently, the displayed screen may display the type of option and its corresponding multiplier (S310). Subsequently, when the winning correspond to a high payout (e.g., 100 times or more), additional effects such as audio announcements through a speaker or visual notifications on the screen may be presented (S320). The presentation effects persist for a predetermined time period and then end (S330). Through such additional winning announcement effects, the game players' immersion and interest in the game may be enhanced.

In addition, for the understanding of the disclosed embodiments, reference numerals are described in the embodiments illustrated in the drawings, and specific terms have been used to describe the disclosed embodiments. However, the disclosed embodiments are not limited by these specific terms, and the disclosed embodiments may include all constituent elements that are conventionally conceivable by those skilled in the art.

The specific implementations described in the disclosed embodiments are merely examples, and the scope of the present invention is not limited thereto. Various modifications and improvements by those skilled in the art, using the basic concepts defined in the following claims, also belong to the right scope of the present invention.

Description of Reference Numerals

| | |
|---|---|
| 10: Game table | 30: Player card area |
| 40: Banker card area | 50: Game player area |
| BA: Betting area | 51: Banker betting area |
| 52: Player betting area | 53: Tie betting area |
| 55: Option betting area | 60: Card reading device |
| 70: Game calculation device | 81: Game display device |
| 83: Speaker | 90: Jackpot calculation device |

1. An apparatus for a baccarat option game, comprising:
a game table including a player card area, a banker card area, and an option betting area;
a card reading device configured to recognize, in order of use, card information including suits and numbers of cards used on the game table;
a game calculation device configured to receive the card information from the card reading device and judge and determine game results; and
a game display device configured to receive the game results from the game calculation device and display the received game results,
wherein at least one of the card reading device or the game calculation device stores at least one of baccarat game rules or predetermined option rules,
wherein the option rules include one or more options and payout rates determined based on the suits and numbers of the cards used in the baccarat game, the option rules being applied independently of the baccarat game rules in each and every round of the baccarat game, and
wherein at least one of the card reading device or the game calculation device is configured to judge and determine a winning of an option when the suits and numbers of the cards used in the baccarat game correspond to the predetermined option.

2. The apparatus of claim 1, wherein the option betting area further includes a betting detection sensor configured to detect a betting amount of chips positioned in the option betting area, and
wherein the betting amount detected by the betting detection sensor is transmitted to the game calculation device.

3. The apparatus of claim 2, further comprising:
a jackpot calculation device configured to receive the betting amount detected by the betting detection sensor and save a portion of the betting amount as a jackpot according to a predetermined jackpot calculation method.

4. The apparatus of claim 1, wherein the game results include winning results of the option, and upon winning of the option, the winning results are displayed as an image on the game display device.

5. The apparatus of claim 1, wherein the card reading device and the game calculation device are configured as a single device.

6. A method for a baccarat option game performed in an apparatus for a baccarat option game comprising a game table including a player card area, a banker card area, and an option betting area, a card reading device configured to distribute cards used on the game table and recognize card information; and
a game calculation device configured to receive information on the cards used in the game from the card reading device, the method comprising:
distributing, by the card reading device, cards to the player card area and the banker card area according to baccarat game rules;
detecting, by a betting detection sensor positioned in the option betting area of the game table, an option betting amount;
transmitting the detected betting amount to the game calculation device;
receiving, by the game calculation device, the card information from the card reading device and, based on the card information; and
judging and determining, by the game calculation device, whether the option has been won or lost according to predetermined option rules,
wherein the option rules include one or more options and corresponding payout rates determined based on suits and numbers of cards disposed in the player card area and the banker card area, and
wherein the game calculation device calculates a winning amount based on a payout rate of an winning option.

7. The method of claim 6, wherein the option rules include a single pair option, which has a predetermined payout rate when first two cards disposed in the player card area have the same number or when first two cards disposed in the banker card area have the same number.

8. The method of claim 7, wherein the option rules include a double pair option, which has a payout rate larger than the payout rate of the single pair option when first two cards disposed in the player card area have the same number and when first two cards disposed in the banker card area have the same number.

9. The method of claim 8, wherein the option rules include a twin pair option, which has a payout rate larger than the payout rate of the double pair option when first two cards disposed in the player card area and first two cards disposed in the banker card area all have the same number.

10. The method of claim 7, wherein the option rules include a single 3-card option, which has a payout rate larger than the payout rate of the single pair option when three cards disposed in the player card area have the same number or when three cards disposed in the banker card area have the same number.

11. The method of claim 10, wherein the option rules include a 3-card & pair option, which has a payout rate larger than the payout rate of the single 3-card option when first two cards disposed in one area of the player card area or the banker card area have the same number, and three cards disposed in the other area have the same number.

12. The method of claim 11, wherein the option rules include a 3-card & twin pair option, which has a payout rate larger than the payout rate of the 3-card & pair option when first two cards disposed in one area of the player card area or the banker card area, and three cards disposed in the other area, all have the same number.

13. The method of claim 11, wherein the option rules include a double 3-cards option, which has a payout rate larger than the payout rate of the 3-card & pair option when three cards disposed in the player card area have the same number and three cards disposed in the banker card area have the same number.

14. The method of claim 13, wherein the option rules include a twin 3-cards option, which has a payout rate larger than the payout rate of the double 3-cards option when three cards disposed in the player card area and three cards disposed in the banker card area all have the same number.

15. The method of claim 6, wherein the option rules include a straight flush option, which has a predetermined payout rate when five cards of cards disposed in the player card area and the banker card area are of the same suit and correspond to consecutive numbers.

16. The method of claim 15, wherein the option rules include a royal straight flush option, which has a payout rate larger than the payout rate of the straight flush option when the consecutive numbers in the straight flush option correspond to Ace (A), King (K), Queen (Q), Jack (J), and 10.

17. The method of claim 6, wherein, when cards disposed in the player card area and the banker card area correspond to multiple option rules, it is judged and determined as a winning for an option with a largest payout amount.

18. A method for a baccarat option game, comprising:
distributing, by the card reading device, cards to the player card area and the banker card area according to baccarat game rules;
detecting, by a betting detection sensor positioned in the option betting area of the game table, an option betting amount;
transmitting the detected betting amount to the game calculation device;
receiving, by the game calculation device, the card information from the card reading device and, based on the card information; and
judging and determining, by the game calculation device, whether the option has been won or lost according to predetermined option rules,
wherein the option rules include one or more options and corresponding payout rates determined based on suits and numbers of cards disposed in the player card area and the banker card area, and
wherein the game calculation device calculates a winning amount based on a payout rate of an winning option.

19. The method of claim 18, wherein the option rules include a single pair option, which has a predetermined payout rate when first two cards disposed in the player card area have the same number or when first two cards disposed in the banker card area have the same number.

20. The method of claim 19, wherein the option rules include a double pair option, which has a payout rate larger than the payout rate of the single pair option when first two cards disposed in the player card area have the same number and when first two cards disposed in the banker card area have the same number.
